(19) United States
(12) Patent Application Publication
(10) Pub. No.: US 2026/0196671 A1
(43) Pub. Date: Jul. 9, 2026

(54) BIPOLAR SOLID STATE BATTERY CELLS

(71) Applicant: Belenos Clean Power Holding AG, Bienne (CH)

(72) Inventor: Reto PFENNINGER, Wangen bei Olten (CH)

(73) Assignee: Belenos Clean Power Holding AG, Bienne (CH)

(21) Appl. No.: 19/130,682

(22) PCT Filed: Nov. 20, 2023
(86) PCT No.: PCT/EP2023/082352

§ 371 Date: May 16, 2025

(30) Foreign Application Priority Data
Dec. 22, 2022 (EP) 22216066.5

(51) Int. Cl. H01M 50/474; H01M 10/0585; H01M 50/46; H01M 50/483; H01M 50/486

(52) U.S. Cl. CPC H01M 50/474; H01M 10/0585; H01M 50/46; H01M 50/483; H01M 50/486

(57) ABSTRACT

A bipolar solid state battery cell including a plurality of electrochemical units, arranged in a stack so that adjacent electrochemical units share an electronic conductor, the plurality of stacked electrochemical units being arranged in series, and the bipolar solid state battery cell including: a cathode current collector; a first electrochemical unit including a first catholyte layer, a first solid state electrolyte, and a first electronic conductor; x second electrochemical units, individually including a second catholyte layer, a second solid state electrolyte, and a second electronic conductor, wherein x is between 0 and 8; a third electrochemical unit including a third catholyte layer and a third solid state electrolyte; an anode current collector; and an electrically insulating layer. The invention further relates to a bipolar solid state battery including a stack of at least two bipolar solid state battery cells.

### TECHNICAL FIELD OF THE INVENTION

The present invention is related to bipolar solid state battery cells, in particular to bipolar solid state battery cells comprising a plurality of stacked electrochemical units The present invention is further related to bipolar solid state batteries comprising a plurality of stacked bipolar solid state battery cells.

### BACKGROUND

Secondary batteries are already known for a while. In the search for secondary batteries having a high energy density and a high power output, bipolar batteries have been developed. In particular bipolar-type lithium-ion secondary batteries, in short bipolar lithium-ion batteries, have gained much interest.

Bipolar battery cells comprise a stack of electrochemical units, which are arranged so as to be in series. To realise such a stack, bipolar electrodes are used between an outer cathode and an outer anode, wherein an electrolyte is present between the cathode and the adjacent bipolar electrode, between the respective adjacent bipolar electrodes, and between the anode and its adjacent bipolar electrode.

EP 1487034 discloses a bipolar battery having a bipolar electrode and an electrolyte layer. The bipolar electrode includes a current collector, a positive electrode layer formed on one surface of the current collector, and a negative electrode layer formed on the other surface of the current collector. The bipolar electrode is sequentially laminated to provide connection in series via the electrolyte layer to form a stack structure. The positive electrode layer, the negative electrode layer and the electrolyte layer are potted with a resin portion. The resin portion of the battery provides a protective means against vibration and impact during operation of the on-vehicle battery and provides the battery with waterproofing, heat resistance, gas-tightness and electrolyte liquid resistance.

A disadvantages of such a bipolar battery element includes a limited power density and energy density, which require large stacks to obtain sufficient power density. Consequently, upon use, a lot of heat is generated, especially within the electrochemical cells in the middle of the stack. This heat tends to accumulate within the battery element, causing deterioration of the electrolyte, such as the release of oxygen, and leading to safety risks and to a limited lifetime of the bipolar battery elements. A further disadvantage is that the resin portion which is used as potting material is known to provide insufficient protection in case of overvoltage in the battery. Further, if liquid electrolytes are used, there is the risk of leaking of electrolyte, causing also a safety risk.

US2009017371 discloses a power storage device comprising a plurality of electrolyte layers which are stacked with an electrode element interposed between them. In order to address the heat dissipation difficulties, the plurality of electrolyte layers include an electrolyte layer provided at a first position in a stacking direction and an electrolyte layer provided at a second position different from the first position, so that head radiation is lower at the second position than at the first position. The electrolyte layer at the second position has a resistance value which is higher than a resistance value of the electrolyte layer at the first position. The electrolyte can be a solid state electrolyte, comprising particles, wherein the particle density at the second position is lower than the particle density at the first position.

A disadvantage of such a bipolar battery is that the set-up is complex, the electrolyte layers requiring different compositions. Further, the bipolar battery remains limited in power density and energy density, and provides limited safety, in particular during use of the battery.

US2008118826 discloses a lithium-ion battery with cell elements including a cathode, an anode, and an electrolyte layer between the cathode and the anode. The electrolyte layer includes an arrangement of insulating particles with a plurality of interstitial spaces there between, with electrolytes occupying at least some of the interstitial spaces.

US2009269665 discloses a bipolar battery having an inorganic solid electrolyte to provide a power storage device capable of preventing reduced energy efficiency of the power storage device and of avoiding variations in temperature distribution.

JP2019140024 discloses a method for laminating a sulfide and an oxide based solid electrolyte layer in an all-solid battery stack of a bipolar type.

Disadvantages of the foregoing bipolar batteries is that they are prone to overcharge and/or overvoltage, thereby providing a limited safety.

### SUMMARY OF THE INVENTION

It is an aim of the present invention to overcome one or more of the foregoing drawbacks. It is an aim of the present invention to provide a bipolar solid state battery element and a bipolar solid state battery having a high power density. It is a further aim of the present invention to provide a bipolar solid state battery element and a bipolar solid state battery having an improved safety compared to the bipolar solid state battery elements and the bipolar solid state batteries of the state of the art.

According to a first aspect of the invention, there is provided a bipolar solid state battery cell as set out in the appended claims.

The bipolar solid state battery cell comprises a plurality of electrochemical units. The plurality of electrochemical units are arranged in a stack so that adjacent electrochemical units share an electronic conductor. Advantageously, the plurality of stacked electrochemical units are arranged in series.

The bipolar solid state battery cell comprises a cathode current collector. The cathode current collector can be any cathode current collector known in the art. Advantageously, the cathode current collector comprises or substantially consists of aluminium.

The bipolar solid state battery cell further comprises a first electrochemical unit. The first electrochemical unit comprises a first catholyte layer, a first solid state electrolyte, and a first electronic conductor.

The first catholyte layer comprises a first active material. The first active material can be any active material known in the art.

Advantageously, the first catholyte layer further comprises an electronically conductive compound and/or and an ionically conductive compound. The first catholyte layer can further comprise a binder. The electronically conductive compound, the ionically conductive compound and the optional binder can be as known in the art.

Advantageously, the first solid state electrolyte comprises or substantially consists of an alkali metal, an alkaline earth metal, a transition metal, or combinations thereof. Preferred examples, without being limited thereto, of the alkali metal include, without being limited thereto, lithium and sodium. For example, the first solid state electrolyte can comprise or substantially consist of Li₇La₃Zr₂O₁₂ (LLZO). Preferred examples, without being limited thereto, of the alkaline earth metal include, without being limited thereto, magnesium. Preferred examples, without being limited thereto, of the transition metal include, without being limited thereto, aluminium.

Advantageously, the first electronic conductor comprises or substantially consists of steel, a steel alloy, titanium, a titanium alloy, glass-like carbon (also known under the registered trademarks vitreous carbon or glassy carbon), or combinations of two or more thereof. Non-limiting examples of steel include stainless steel, carbon steel and A36.

Optionally, the first electrochemical unit further comprises a first anode layer. The first anode layer can be any anode layer known in the art. Advantageously, when present, the first anode layer comprises or substantially consists of an alkali metal, an alkaline earth metal, a transition metal, graphite, silicon, a carbide, or combinations of two or more thereof.

The bipolar solid state battery cell further comprises x second electrochemical units. Advantageously, x is between 0 and 20, such as between 0 and 15, preferably between 0 and 10, more preferably between 0 and 8, for example between 0 and 5, or between 0 and 1. As will be understood, when x is 0, the bipolar solid state battery cell comprises two electrochemical units, i.e. the first and the third electrochemical units, whereas the bipolar solid state battery cell does not comprise any second electrochemical units.

Each second electrochemical unit, when present (i.e. when x is between 1 et 8), individually comprises a second catholyte layer, a second solid state electrolyte, and a second electronic conductor.

The second catholyte layer comprises a second active material. The second active material is advantageously as described hereinabove for the first active material. Advantageously, the second catholyte layer further comprises an electronically conductive compound and/or and an ionically conductive compound. The second catholyte layer can further comprise a binder. The electronically conductive compound, the ionically conductive compound and the optional binder can be as known in the art.

When the bipolar solid state battery cell comprises at least two second electrochemical units (i.e. x is between 2 and 8), the second electrochemical units can have the same or a different (second) catholyte layer. It will be understood that the catholyte layer of each one of the second electrochemical units can be the same as or different from the first catholyte layer of the first electrochemical unit.

Advantageously, the second solid state electrolyte is as described hereinabove for the first solid state electrolyte. When the bipolar solid state battery cell comprises two or more second electrochemical units (i.e. x is between 2 and 8), the second electrochemical units can have the same or a different (second) solid state electrolyte. It will be understood that the solid state electrolyte of each one of the second electrochemical units can be the same as or different from the first solid state electrolyte of the first electrochemical unit.

Advantageously, the second electronic conductor is as described hereinabove for the first electronic conductor. When the bipolar solid state battery cell comprises two or more second electrochemical units (i.e. x is between 2 and 8), the second electrochemical units can have the same or a different (second) electronic conductor. It will be understood that the electronic conductor of each one of the second electrochemical units can be the same as or different from the first electronic conductor of the first electrochemical unit.

Optionally, when present (i.e. when x is between 1 and 8), the second electrochemical unit can further comprise a second anode layer. When the solid state battery cell comprises two or more second electrochemical units (i.e. x is between 2 and 8), some or all of the second electrochemical units can comprise a second anode layer. Advantageously, when present, each second anode layer individually is as described hereinabove for the optional first anode layer.

When the bipolar solid state battery cell comprises two or more second electrochemical units (i.e. x is between 2 and 8), the second electrochemical units can have the same or a different second anode layer. It will be understood that whether one or more of the second electrochemical units, when x is between 1 and 8, comprise a second anode layer is independent from whether the first electrochemical unit comprises a (first) anode layer. It will also be understood that the anode layer of each one of the second electrochemical units can be the same as or different from the first anode layer of the first electrochemical unit, when present.

The bipolar solid state battery cell further comprises a third electrochemical unit. The third electrochemical unit comprises a third catholyte layer and a third solid state electrolyte.

The third catholyte layer comprises a third active material. The third active material is advantageously as described hereinabove for the first active material. Advantageously, the third catholyte layer further comprises an electronically conductive compound and/or and an ionically conductive compound. The third catholyte layer can further comprise a binder. The electronically conductive compound, the ionically conductive compound and the optional binder can be as known in the art.

Advantageously, the third solid state electrolyte is as described hereinabove for the first solid state electrolyte. It will be understood that the solid state electrolyte of the third electrochemical unit can be the same as or different from the solid state electrolyte of the first electrochemical unit and/or, when x is between 1 and 8, of the second electrochemical unit(s).

Optionally, the third electrochemical unit further comprises a third anode layer. Advantageously, when present, the third anode layer is advantageously as described hereinabove for the optional first and/or the optional second anode layer. It will be understood that the anode layer of the third electrochemical unit, when present, can be the same as or different from the anode layer of the first electrochemical unit, when present, and/or, when x is between 1 and 8, of the second electrochemical unit(s), when present.

The bipolar solid state battery cell further comprises an anode current collector. The anode current collector can be any anode current collector known in the art. Advantageously, the anode current collector comprises or substantially consists of copper.

The bipolar solid state battery cell further comprises an electrically insulating layer. Advantageously, the electrically insulating layer is arranged so as to electrically resist the voltage of the bipolar solid state battery cell, when in use.

Advantageously, the electrically insulating layer is provided at the exterior surface of the cathode current collector and/or at the exterior surface of the anode current collector. Advantageously, the electrically insulating layer is provided at the exterior surface of the cathode current collector. Advantageously and alternatively, the electrically insulating layer is provided at the exterior surface of the anode current collector.

With “exterior surface” of a layer of the bipolar solid state battery cell is meant in the present disclosure the surface facing the outside of the battery cell, i.e. the surface opposite to the surface facing the solid state electrolyte.

Advantageously, the electrically insulating layer comprises or substantially consists of a polymer, a ceramic material, or a combination of two or more thereof.

Advantageously, without being limited thereto, the polymer is selected from the group consisting of polyethylene, polypropylene, polystyrene, polytetrafluoroethylene, cellulose, viscose, natural rubber, and synthetic rubber.

Advantageously, without being limited thereto, the ceramic material is selected from the group consisting of glass, metal oxide, metal nitride, porcelain, and mica. A preferred example of a metal oxide is alumina. A preferred example of a metal nitride is boron nitride.

According to a second aspect of the invention, there is provided a bipolar solid state battery as set out in the appended claims.

The bipolar solid state battery comprises or substantially consists of at least two bipolar solid state battery cells. The bipolar solid state battery cells are stacked. Advantageously, at least one, and preferably all, of the at least two bipolar solid state battery cells are according to the first aspect of the present disclosure.

Advantageously, the cathode current collectors of at least two, and preferably each one, of the at least two bipolar solid state battery cells are electronically connected together, in particular by connection to a cathode tab. This advantageously allows easy coupling of the cathode current collectors to the electronic circuitry, in particular the external electronic circuitry (i.e. outside or at the exterior of the battery cell).

Similarly, and advantageously, the anode current collectors of at least two, and preferably each one, of the at least two bipolar solid state battery cells are electronically connected together, in particular by connection to an anode tab. This advantageously allows easy coupling of the anode current collectors to the electronic circuitry, in particular the external electronic circuitry (i.e. outside or at the exterior of the battery cell).

Advantages of the bipolar solid state battery cells of the present disclosure include, without being limited thereto, an improved functionality as a plurality of electrochemical cells can be stacked, as well as an improved safety and reduced, even minimized, risk of thermal runaway, thereby protecting the components of the battery cell, in particular the catholyte, the anode (if present) and/or the electrolyte. Safety is further improved by a reduced risk of leaking of harmful gases being released from the chemistry of the battery components.

A further advantage of the bipolar solid state battery cells of the present disclosure is the capability to stack a plurality of the bipolar SSB cells, thereby obtaining a bipolar solid state battery having increased safety compared to existing SSBs. The increased safety is obtained by, without being limited thereto, ensuring protection against thermal runaway, in particular during overvoltage or overcharge conditions.

### DESCRIPTION OF THE DRAWINGS

Aspects of the invention will now be described in more detail with reference to the appended drawings, wherein same reference numerals illustrate same features and wherein:

FIGS. 1 to 9, individually, schematically represent a bipolar solid state battery cell according to the present disclosure,

FIG. 10 schematically represents a bipolar solid state battery according to the present disclosure.

### DETAILED DESCRIPTION OF THE INVENTION

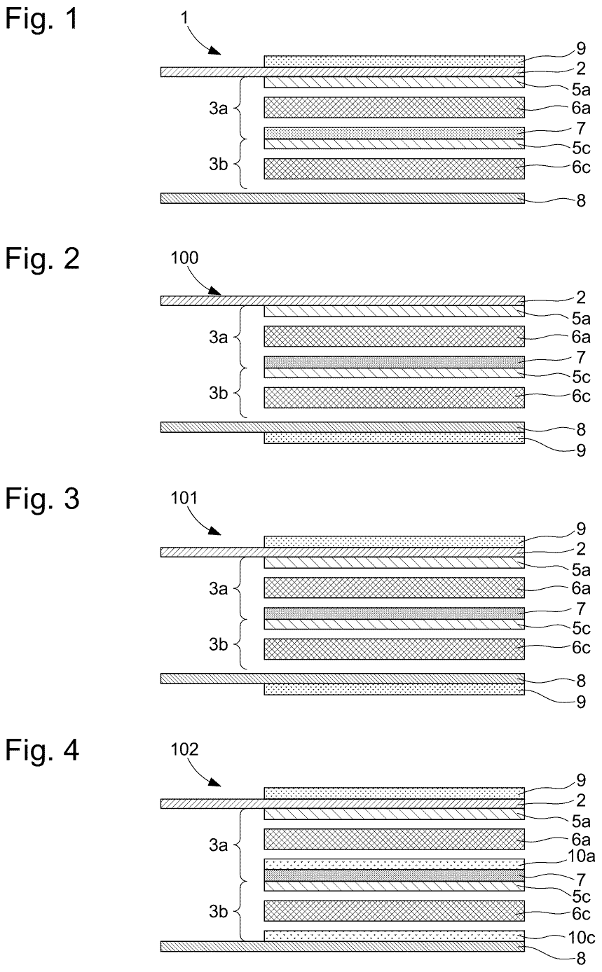

FIG. 1 schematically shows a bipolar solid state battery cell 1 according to the present disclosure. The bipolar solid state battery cell 1 comprises a cathode current collector 2, a first electrochemical unit 3a, a third electrochemical unit 3b and an anode current collector 8. The bipolar solid state battery cell 1 does not comprise any second electrochemical units, i.e. x is 0.

Advantageously, the anode current collector 8 is as described hereinabove. Advantageously, the cathode current collector 2 is as described hereinabove.

Advantageously, and as is known in the art, the cathode current collector 2 extends from the bipolar solid state battery cell 1. In other words, the cathode current collector 2 advantageously has a portion extending or protruding from the stack comprising the first electrochemical unit 3a and the third electrochemical unit 3b. This can be realised by means of methods known in the art, for example by providing a cathode current collector 2 having a surface area that is larger than the surface area of the components of the first electrochemical unit 3a. As is known, such an extension or protrusion allows easy connection or coupling of the cathode current collector 2 to any electronic circuitry (not shown) to which the anode current collector 8 is also advantageously connected or coupled. Such electronic circuitry comprises in particular any external electronic circuitry, i.e. electronic circuitry at the outside or exterior of the battery cell.

Advantageously, and as is known in the art, the anode current collector 8 extends from the bipolar solid state battery cell 1. In other words, the anode current collector 8 advantageously has a portion extending or protruding from the stack comprising the first electrochemical unit 3a and the third electrochemical unit 3b. This can be realised by means of methods known in the art, for example by providing an anode current collector 8 having a surface area that is larger than the surface area of the components of the third electrochemical unit 3b. As is known, such an extension or protrusion allows easy connection or coupling of the anode current collector 8 to any electronic circuitry (not shown) to which the cathode current collector 2 is advantageously also connected or coupled. Such electronic circuitry comprises in particular any external electronic circuitry, i.e. electronic circuitry at the outside or exterior of the battery cell.

An electrically insulating layer 9 is provided at the surface of the cathode current collector 2 opposite to the surface facing the first electrochemical unit 3a.

Advantageously, upon stacking two or more bipolar solid state battery cells 1, thereby obtaining a bipolar solid state battery, the electrically insulating layer 9 is capable of electrically insulating adjacent bipolar solid state battery cells 1. In other words, the electrically insulating layer 9 is provided so that no current passes from one bipolar solid state battery cell 1 to an adjacent bipolar solid state battery cell 1 below a given threshold.

Advantageously, the threshold is defined by the thickness of the electrically insulating layer 9 and its dielectric constant. As is known, the dielectric constant is defined by the material(s) of which the electrically insulating layer 9 is composed.

Advantageously, the thickness of the electrically insulating layer 9 is selected according to a specific value of a voltage defined by the electrochemical units (3a, 3b, and 4 (not present in FIG. 1)) of the bipolar solid state battery cell 1 and according to a set value of the voltage defining safe operation conditions of the bipolar solid state battery cell 1.

Advantageously, the material, the dielectric constant and/or the thickness of the electrically insulating layer 9 are selected so that the level of electrical insulation required by the bipolar solid state battery cells 1 to avoid damages to the electrochemical units is ensured. Hence, the electrically insulating layer 9 is to be considered as a tuneable dielectric break-through circuit element. Advantageously, the dielectric constant, the material and/or the thickness are chosen so that the electrically insulating layer 9 matches the desired dielectric breakthrough voltage.

Advantageously, when the total charge voltage for the bipolar solid state battery cell 1 exceeds a certain value, the electrically insulating layer 9 enters a dielectric breakthrough state. Advantageously, in this dielectric breakthrough state, the electrically insulating layer 9 becomes electrically conductive. Consequently, the electrically insulating layer 9 in dielectric breakthrough state allows the current to bypass the electrochemical units 3a and 3b (and 4 (not present in FIG. 1)), thereby avoiding damage to the electrochemical units 3a, 3b and 4 (not present in FIG. 1).

In other words, the electrically insulating layer 9 can advantageously be considered to function as a Zehnerdiode. In normal operating conditions, the electrically insulating layer 9 acts as an insulator. In extreme conditions, in particular when overvoltage and/or overcurrent occurs, the electrically insulating layer 9 becomes electrically conductive, thereby preventing thermal runaway. Advantageously, thermal runaway is prevented by by-passing the energy through an engineered short circuit comprising the electrically insulating layer 9. Consequently, the electrical energy is advantageously not absorbed by the catholyte, the anode (if present, not shown in FIG. 1) and/or the electrolyte, thereby avoiding damage thereto.

Advantageously, the electrically insulating layer 9 is provided so that the layer 9 protects adjacent bipolar solid state battery cells stacked into a bipolar solid state battery from overvoltage at a value greater than 1, such as at least 1.1 times, at least 1.2 times, at least 1.25 times, at least 1.5 times, at least 1.75 times, or at least 2 times, the nominal charging voltage of the bipolar solid state battery cell. In particular, the electrically insulating layer 9 is provided so that the bipolar solid state battery comprising a stack of at least 2 bipolar solid state battery cells is considered safe according to the UN38 Test.

The first electrochemical unit 3a comprises a first catholyte layer 5a, a first solid state electrolyte 6a, and a first electronic conductor 7.

Advantageously, the first catholyte layer 5a is as described hereinabove. Advantageously, the first catholyte layer 5a comprises between 50% and 100% by weight of the first active material, based on the total weight of the first catholyte layer 5a.

Advantageously, the first solid state electrolyte 6a is as described hereinabove.

Advantageously, the first electronic conductor 7 is as described hereinabove. Advantageously, the first electronic conductor 7 is provided so as to limit, and even to substantially block, the transfer of ions between the first 3a and the third 3b electrochemical unit. In other words, the electronic conductor advantageously provides ionic resistance while ensuring electronical conductivity between the adjacent electrochemical units 3a, 3b. Consequently, as there is electronical conductivity between the adjacent electrochemical units 3a, 3b, the first 3a and the third 3b electrochemical unit of the bipolar solid state battery cell 1 are considered to be connected in series.

The third electrochemical unit 3b comprises a third catholyte layer 5c and a third solid state electrolyte 6c. Advantageously, the third catholyte layer 5c is as described hereinabove. Advantageously, the third solid state electrolyte 6c is as described hereinabove.

Advantageously, the third catholyte layer 5c comprises between 50% and 100% by weight of the third active material, based on the total weight of the third catholyte layer 5c.

FIG. 2 shows another bipolar solid state battery cell 100 according to the present disclosure. The bipolar solid state battery cell 100 comprises a cathode current collector 2, a first electrochemical unit 3a, a third electrochemical unit 3b and an anode current collector 8, which are all advantageously as described hereinabove.

The bipolar solid state battery cell 100 further comprises an electrically insulating layer 9. The electrically insulating layer 9 is provided at the side or surface of the anode current collector 8 opposite to the side or surface adjacent to the third electrochemical unit 3b. The electrically insulating layer 9 is advantageously as described hereinabove.

FIG. 3 shows yet another bipolar solid state battery cell 101 according to the present disclosure. The bipolar solid state battery cell 101 comprises a cathode current collector 2, a first electrochemical unit 3a, a third electrochemical unit 3b and an anode current collector 8, which are all advantageously as described above.

The bipolar solid state battery cell 101 further comprises a first electrically insulating layer 9 provided at the side of the cathode current collector 2 opposite to the side adjacent to the first electrochemical unit 3a. The bipolar solid state battery cell 101 further comprises a second electrically insulating layer 9 provided at the side of the anode current collector 8 opposite to the side adjacent to the third electrochemical unit 3b. The electrically insulating layers 9 are advantageously as described hereinabove.

By providing an electrically insulating layer 9 at both (opposite) sides of the bipolar solid state battery cell 101 (thus when providing two electrically insulating layers 9), each electrically insulating layer 9 can advantageously be, upon stacking the bipolar solid state battery cells 101 to obtain a bipolar solid state battery, thinner than when a single electrically insulating layer 9 is provided, as each electrically insulating layer 9 contributes to the electrical insulation of the (adjacent) bipolar solid state battery cells 101 of the bipolar solid state battery.

FIG. 4 shows a bipolar solid state battery cell 102 according to yet another embodiment of the invention. The bipolar battery cell 102 comprises an electrically insulating layer 9 provided at the surface of a cathode current collector 2 opposite to the surface of the cathode current collector 2 adjacent to a first electrochemical unit 3a. The bipolar solid state battery cell 102 further comprises a third electrochemical unit 3b, and an anode current collector 8. Advantageously, each of the electrically insulating layer 9, the anode current collector 8 and the cathode current collector 2 are as described hereinabove.

The first electrochemical unit 3a comprises a first catholyte 5a, a first solid state electrolyte 6a, a first anode layer 10a, and a first electronic conductor 7. The first anode layer 10a is advantageously provided between the first solid state electrolyte 6a and the first electronic conductor 7. Advantageously, each of the first catholyte 5a, the first solid state electrolyte 6a, the first anode layer 10a, and the first electronic conductor 7 are as described hereinabove.

The third electrochemical unit 3b comprises a third catholyte 5c, a third solid state electrolyte 6c, and a third anode layer 10c. The third anode layer 10c is advantageously provided between the third solid state electrolyte 6c and the anode current collector 8. Advantageously, each of the third catholyte 5c, the third solid state electrolyte 6c and the third anode layer 10c are as described hereinabove.

Advantageously, the first 10a and/or the third 10c anode layer comprises or substantially consists of a metallic layer. The metal of the metallic layer can be the same or different as one of the metals comprised in the cathode, e.g. in the active material of the cathode. For example, when the cathode comprises lithium, the anode layer advantageously is a metallic layer comprising or substantially consisting of lithium. For example, the anode layer can be a lithium foil, optionally doped, or substituted, with aluminium.

Alternatively, and also advantageously, the anode comprises or substantially consists of an intercalation anode. Non-limiting examples of suitable intercalation electrodes include graphite and Li₄Ti₅O₁₂, or combinations thereof.

Alternatively, and also advantageously, the first 10a and/or the third 10c anode layer comprises or substantially consists of a conversion electrode. Advantageously, the conversion electrode comprises or substantially consists of an oxide, a nitride a sulphide, or combinations of two or more thereof. Non limiting examples of oxides include LiVO₂ and SnO₂. Non-limiting examples of nitrides include vanadium nitride (VN) and molybdenum nitride (δ-MoN). Non-limiting examples of sulphides include tin sulphide (SnSₓ) and vanadium sulphide (VS₂ and VS₄).

Advantageously the first 10a and/or the third 10c anode layer can be provided by means known in the art, such as by providing a film, sheet or foil, or by deposition of a layer by known methods, such as sputtering and plasma deposition.

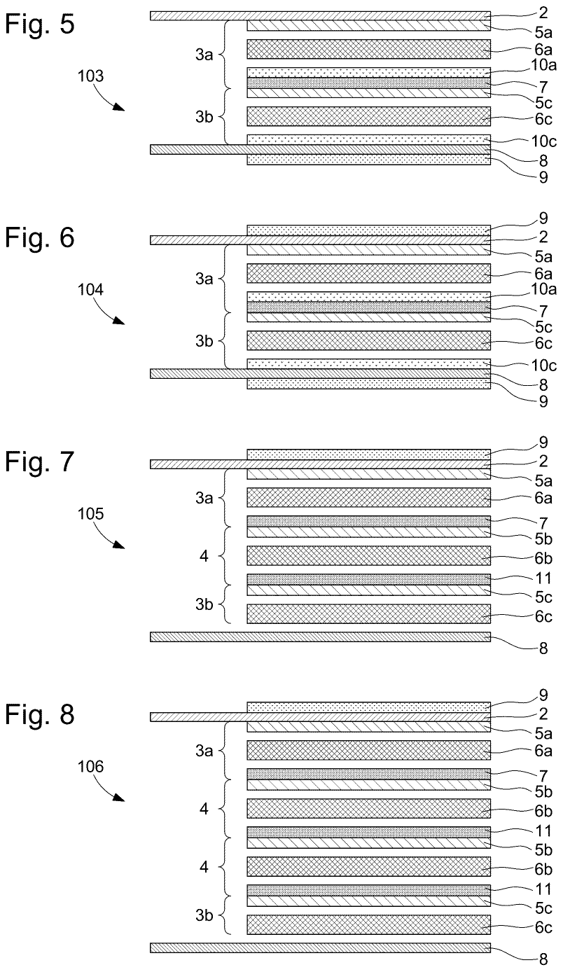

FIG. 5 shows a bipolar solid state battery cell 103 according to yet another embodiment of the invention. The bipolar battery cell 103 comprises an electrically insulating layer 9 provided at the surface of an anode current collector 8 opposite to the surface of the anode current collector 8 adjacent to a third electrochemical unit 3b. The bipolar solid state battery cell 103 further comprises a first electrochemical unit 3a, and a cathode current collector 2. Advantageously, each of the electrically insulating layer 9, the anode current collector 8 and the cathode current collector 2 are as described hereinabove.

The first 3a and the third 3b electrochemical units are advantageously as described hereinabove for the bipolar solid state battery cell 102 of FIG. 4, and comprise a first 10a and a third 10c anode layer, respectively.

FIG. 6 shows a bipolar solid state battery cell 104 according to yet another embodiment of the invention. The bipolar battery cell 104 comprises an electrically insulating layer 9 provided at the surface of a cathode current collector 2 opposite to the surface of the cathode current collector 2 adjacent to a first electrochemical unit 3a. The bipolar battery cell 104 further comprises a second electrically insulating layer 9 provided at the surface of an anode current collector 8 opposite to the surface of the anode current collector 8 adjacent to a third electrochemical unit 3b.

Advantageously, each of the electrically insulating layer 9, the anode current collector 8 and the cathode current collector 2 are as described hereinabove. Advantageously, the first 3a and the third 3b electrochemical units are as described hereinabove for the bipolar solid state battery cell 102 of FIG. 4, and thus comprise a first 10a and a third 10c anode layer, respectively.

FIG. 7 shows a bipolar solid state battery cell 105 according to a further embodiment of the invention. The bipolar battery cell 105 comprises an electrically insulating layer 9 provided at the surface of a cathode current collector 2 opposite to the surface of the cathode current collector 2 adjacent to a first electrochemical unit 3a. The bipolar solid state battery cell 105 further comprises a third electrochemical unit 3b and an anode current collector 8.

The first electrochemical unit 3a advantageously comprises a first catholyte 5a, a first electrolyte 6a and a first electronic conductor 7, which are advantageously as described hereinabove.

The third electrochemical unit 3b advantageously comprises a third catholyte 5c and a third electrolyte 6c, which are advantageously as described hereinabove.

The bipolar solid state battery cell 105 further comprises one second electrochemical unit 4, i.e. x is 1. The second electrochemical unit 4 comprises a second catholyte 5b, a second solid state electrolyte 6b, and a second electronic conductor 11. Advantageously, the second catholyte 5b and the second solid state electrolyte 6b are as described hereinabove. Advantageously, the second electronic conductor 11 is as described hereinabove, in particular as described hereinabove for the first electronic conductor 7.

Advantageously, the first electronic conductor 7 of the first electrochemical unit 3a is provided so as to limit, and even to substantially block, the transfer of ions between the first 3a and the second 4 electrochemical unit. In other words, the first electronic conductor 7 advantageously provides ionic resistance while ensuring electronic conductivity between the adjacent electrochemical units 3a and 4.

Advantageously, the second electronic conductor 11 of the second electrochemical unit 4 is provided so as to limit, and even to substantially block, the transfer of ions between the second 4 and the third 3b electrochemical unit. In other words, the second electronic conductor 11 advantageously provides ionic resistance while ensuring electronic conductivity between the adjacent electrochemical units 4 and 3b.

FIG. 8 shows a bipolar solid state battery cell 106 according to yet a further embodiment of the invention. The bipolar battery cell 106 comprises an electrically insulating layer 9 provided at the surface of a cathode current collector 2 opposite to the surface of the cathode current collector 2 adjacent to a first electrochemical unit 3a. The bipolar solid state battery cell 106 further comprises a third electrochemical unit 3b and an anode current collector 8. The first 3a and the third 3b electrochemical unit are advantageously as described for the bipolar solid state battery cell 105 of FIG. 7.

The bipolar solid state battery cell 106 further comprises two second electrochemical units 4, i.e. x is 2. Each of the second electrochemical units 4 advantageously comprises a second catholyte 5b, a second solid state electrolyte 6b, and a second electronic conductor 11. Advantageously, the second catholytes 5b, individually, the second solid state electrolytes 6b, individually, and the second electronic conductors 11, individually, are as described hereinabove.

Advantageously, the second electronic conductor 11 of the first second electrochemical unit 4 is provided so as to limit, and even to substantially block, the transfer of ions between the adjacent second electrochemical units 4. Advantageously, the second electronic conductor 11 of the second second electrochemical unit 4 is provided so as to limit, and even to substantially block, the transfer of ions between the second 4 and the third 3b electrochemical unit.

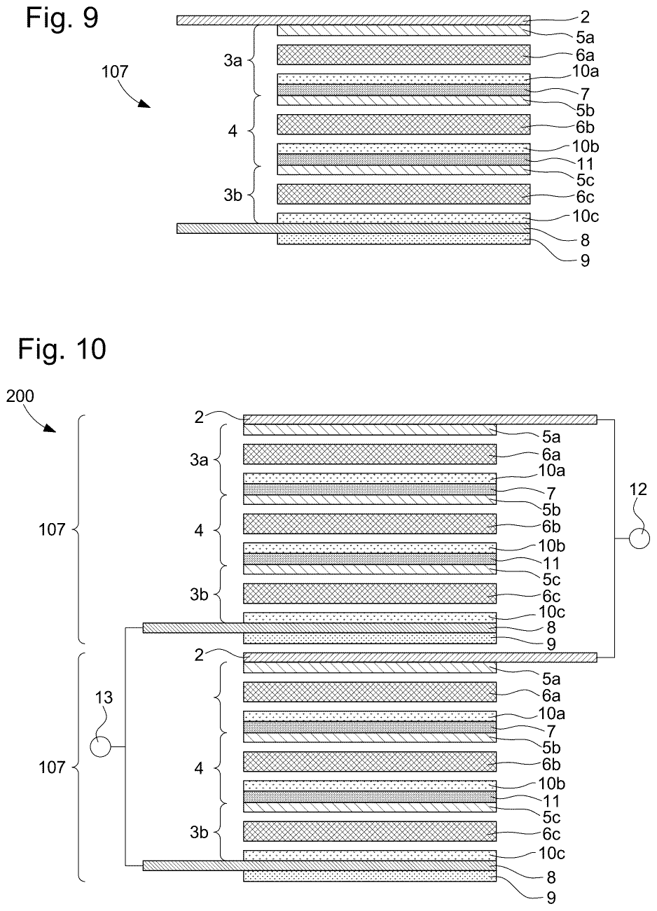

FIG. 9 shows a bipolar solid state battery cell 107 according to yet another embodiment of the invention. The bipolar battery cell 107 comprises an electrically insulating layer 9 provided at the surface of an anode current collector 8 opposite to the surface of the anode current collector 8 adjacent to a third electrochemical unit 3b. The bipolar solid state battery cell 106 further comprises a first electrochemical unit 3a and a cathode current collector 2.

The first electrochemical unit 3a advantageously comprises a first catholyte 5a, a first electrolyte 6a, a first anode layer 10a and a first electronic conductor 7, which are advantageously as described hereinabove.

The third electrochemical unit 3b advantageously comprises a third catholyte 5c, a third electrolyte 6c and a third anode layer 10c, which are advantageously as described hereinabove.

The bipolar solid state battery cell 107 further comprises one second electrochemical unit 4, i.e. x is 1. The second electrochemical unit 4 comprises a second catholyte 5b, a second solid state electrolyte 6b, a second anode layer 10b, and a second electronic conductor 11. Advantageously, the second catholyte 5b, the second solid state electrolyte 6b, the second anode layer 10b, and the second electronic conductor 11 are as described hereinabove.

FIG. 10 shows a bipolar solid state battery 200 according to the present disclosure. The bipolar solid state battery 200 comprises a stack of two bipolar solid state battery cells 107. The presence of the electrically insulating layer 9 allows the individual bipolar solid state battery cells 107 to function safely as described hereinabove.

The cathode current collectors 2 of the bipolar solid state battery cells 107 advantageously extend or protrude from the stack comprising the first 3a, the second 4 and the third 3b electrochemical unit. This allows easy connection thereof to one another. As shown in FIG. 10, the cathode current collectors 2 of the bipolar solid state battery cells 107 are electronically connected by means of a cathode tab 12.

The anode current collectors 8 of the bipolar solid state battery cells 107 advantageously extend or protrude from the stack comprising the first 3a, the second 4 and the third 3b electrochemical unit. This allows easy connection thereof to one another. As shown in FIG. 10, the anode current collectors 8 of the bipolar solid state battery cells 107 are electronically connected by means of an anode tab 13.

Advantageously, the cathode current collectors 2 extend or protrude in a first direction, and the anode current collectors 8 extend or protrude in a second direction different from the first direction. This allows easy connection of the cathode current collectors 2 to the cathode tab 12, and also of the anode current collectors 8 to the anode tab 13.

### EXAMPLES

### Example 1

A bipolar solid state battery cell 102 according to the schematic representation of FIG. 4 was manufactured (i.e. x is 0).

An aluminium sheet was used for the cathode current collector 2. A copper foil was used for the anode current collector 8.

The first 5a and the third 5c catholyte comprised NMC as active material, carbon nanotubes (CNT) as electronically conductive compound and LLZO as ionically conductive compound.

The first 6a and the third 6c solid state electrolyte comprised LLZO. A 25 μm thick lithium foil was provided as first 10a and third 10c anode layer. The first electronic conductor 7 was a 8 μm thick stainless steel foil.

A polyethylene foil having a thickness between 600 nm and 800 nm was provided as electrically insulating layer 9 at the side of the aluminium cathode current collector 2 opposite to the side thereof adjacent to the first catholyte 5a.

All layers were provided on top of each other in an argon atmosphere to avoid contamination, and the bipolar solid state battery cell was sealed with a pneumatic press.

The voltage was measured, and was determined to be between 8.4 V and 8.8 V, or between 4.2 V and 4.4 V over the cathode current collector 2 and the electronic conductor 7 of the first electrochemical unit 3a, and between 4.2 V and 4.4 V over the electronic conductor 7 and the anode current collector 8 via the third electrochemical unit 3b.

### NOMENCLATURE

1. bipolar solid state battery cell
2. cathode current collector
3a. first electrochemical unit
3b. third electrochemical unit
4. second electrochemical unit
5a. first catholyte layer
5b. second catholyte layer
5c. third catholyte layer
6a. first solid state electrolyte
6b. second solid state electrolyte
6c. third solid state electrolyte
7. first electronic conductor
8. anode current collector
9. electrically insulating layer
10a. first anode layer
10b. second anode layer
10c. third anode layer
11. second electronic conductor
12 cathode tab for external connection
13 anode tab for external connection
100. bipolar solid state battery cell
101. bipolar solid state battery cell
102. bipolar solid state battery cell
103. bipolar solid state battery cell
104. bipolar solid state battery cell
105. bipolar solid state battery cell
106. bipolar solid state battery cell
107. bipolar solid state battery cell
200. bipolar solid state battery

1-14. (canceled)

15. A bipolar solid state battery cell comprising a plurality of electrochemical units arranged in a stack so that adjacent electrochemical units share an electronic conductor, the bipolar solid state battery cell, comprising:
a cathode current collector;
a first electrochemical unit comprising a first catholyte layer comprising a first active material, a first solid state electrolyte, and a first electronic conductor;
x second electrochemical units, wherein each second electrochemical unit individually comprises a second catholyte layer comprising a second active material, a second solid state electrolyte, and a second electronic conductor;
a third electrochemical unit comprising a third catholyte layer comprising a third active material, and a third solid state electrolyte; and
an anode current collector;
wherein the plurality of stacked electrochemical units are arranged in series, wherein the number x of second electrochemical units is between 0 and 8,
characterised in that the bipolar solid state battery cell further comprises an electrically insulating layer provided at the exterior surface of the cathode current collector and/or at the exterior surface of the anode current collector, and comprising a ceramic material.

16. The bipolar solid state battery cell according to claim 15, wherein the electrically insulating layer is arranged so as to electrically resist the voltage of the bipolar solid state battery cell, when in use.

17. The bipolar solid state battery cell according to claim 15, wherein the electrically insulating layer further comprises a polymer.

18. The bipolar solid state battery cell according to claim 17, wherein the polymer is selected from the group consisting of polyethylene, polypropylene, polystyrene, polytetrafluoroethylene, cellulose, viscose, natural rubber, and synthetic rubber.

19. The bipolar solid state battery cell according to claim 15, wherein the ceramic material is selected from the group consisting of glass, metal oxide, metal nitride, porcelain, and mica.

20. The bipolar solid state battery cell according to claim 15, wherein the first electronic conductor and the second electronic conductor(s), individually, comprise steel, a steel alloy, titanium, a titanium alloy, glass-like carbon, or combinations of two or more thereof.

21. The bipolar solid state battery cell according to claim 15, wherein the first electrochemical unit further comprises a first anode layer, and/or the third electrochemical unit further comprises a third anode layer.

22. The bipolar solid state battery cell according to claim 15, wherein x is between 1 and 8, and wherein the second electrochemical units, individually, further comprise a second anode layer.

23. The bipolar solid state battery cell according to claim 21, wherein the anode layer comprises an alkali metal, an alkaline earth metal, a transition metal, graphite, silicon, a carbide, or combinations of two or more thereof.

24. The bipolar solid state battery cell according to claim 15, wherein the first solid state electrolyte, the second solid state electrolyte, if present, and the third solid state electrolyte, individually, comprise an alkali metal, an alkaline earth metal, a transition metal, or combinations thereof, preferably lithium, sodium, magnesium or aluminium, more preferably Li₇La₃Zr₂O₁₂.

25. The bipolar solid state battery cell according to claim 15, wherein the first catholyte layer, the second catholyte layer, if present, and the third catholyte layer, individually, further comprise one or more of an electronically conductive compound, and an ionically conductive compound.

26. A bipolar solid state battery comprising a stack of at least two bipolar solid state battery cells according to claim 15.

27. The bipolar solid state battery according to claim 26, wherein the cathode current collectors of each one of the at least two bipolar solid state battery cells are electronically connected to a cathode tab.

28. The bipolar solid state battery according to claim 26, wherein the anode current collectors of each one of the at least two bipolar solid state battery cells are electronically connected to an anode tab.
